(19) United States
(12) Patent Application Publication
(10) Pub. No.: US 2012/0237676 A1
(43) Pub. Date: Sep. 20, 2012

(54) SOL-GEL BASED FORMULATIONS AND METHODS FOR PREPARATION OF HYDROPHOBIC ULTRA LOW REFRACTIVE INDEX ANTI-REFLECTIVE COATINGS ON GLASS

(75) Inventors: Nikhil D. Kalyankar, Hayward, CA (US); Nitin Kumar, Fremont, CA (US)

(73) Assignee: Intermolecular, Inc., San Jose, CA (US)

(21) Appl. No.: 13/046,899

(22) Filed: Mar. 14, 2011

(51) Int. Cl. B05D 5/00; B05D 3/00; C09D 7/12; B05D 3/02

(52) U.S. Cl. 427/243; 106/287.1; 106/287.26

(57) ABSTRACT

Embodiments of the invention relate generally to methods and compositions for forming porous low refractive index coatings on substrates. In one embodiment, a method of forming a porous coating on a substrate is provided. The method comprises coating a substrate with a sol-gel composition comprising at least one self assembling molecular porogen and annealing the coated substrate to remove the at least one self assembling molecular porogen to form the porous coating. Use of the self assembling molecular porogens leads to the formation of stable pores with larger volume and an increased reduction in the refractive index of the coating. Further, the size and interconnectivity of the pores may be controlled via selection of the self assembling molecular porogens structure, the total porogen fraction, polarity of the molecule and solvent, and other physiochemical properties of the gel phase.

### BACKGROUND OF THE INVENTION

1. Field of the Invention

Embodiments of the invention relate generally to methods and compositions for forming porous low refractive index coatings on substrates.

2. Description of the Related Art

Coatings that provide low reflectivity or a high percent transmission over a broad wavelength range of light are desirable in many applications including semiconductor device manufacturing, solar cell manufacturing, glass manufacturing, and energy cell manufacturing. The transmission of light through a material causes the wavelength of the light to change, a process known as refraction, while the frequency remains unchanged thus changing the speed of light in the material. The refractive index of a material is a measure of the speed of light in the material which is generally expressed as a ratio of the speed of light in vacuum relative to that in the material. Low reflectivity coatings generally have a refractive index (n) in between air (n=1) and glass (n˜1.5).

An antireflective (AR) coating is a type of low reflectivity coating applied to the surface of a transparent article to reduce reflectivity of visible light from the article and enhance the transmission of such light into or through the article thus decreasing the refractive index. One method for decreasing the refractive index and enhancing the transmission of light through an AR coating is to increase the porosity of the antireflective coating. Porosity is a measure of the void spaces in a material. Although such antireflective coatings have been generally effective in providing reduced reflectivity over the visible spectrum, the coatings have suffered from deficiencies when used in certain applications. For example, porous AR coatings which are used in solar applications are highly susceptible to moisture absorption.

Moisture absorption may lead to an increase in the refractive index of the AR coating and corresponding reduction in light transmission.

Thus, there is a need for AR coatings which exhibit increased reliability and durability.

### SUMMARY OF THE INVENTION

Embodiments of the invention relate generally to methods and compositions for forming porous low refractive index coatings on substrates. In one embodiment, a method of forming a porous coating on a substrate is provided. The method comprises coating a substrate with a sol-gel composition comprising at least one self assembling molecular porogen and removing the at least one self assembling molecular porogen to form the porous coating.

In another embodiment, a composition for forming a sol-gel system is provided. The composition comprises a film forming precursor, an acid or base containing catalyst, an alcohol containing solvent, a self assembling molecular porogen, and water. The self assembling molecular porogen may be present in the sol-gel system in an amount comprising at least 0.1 wt. % to about 5 wt. % of the total weight of the sol-gel system.

In yet another embodiment, a method of making a sol-gel system is provided. The method comprises mixing a film forming precursor, an acid or base containing catalyst, water, and an alcohol containing solvent to form a reaction mixture by at least one of a hydrolysis and polycondensation reaction and subsequently adding at least one self assembling molecular porogen to the reaction mixture.

In yet another embodiment, a molecular porogen which may be a self assembling molecular porogen is added in quantities ranging from 0.01 to 0.1 wt. % in the beginning of at least one of a hydrolysis and polycondensation reaction along with the film forming precursor, alcohol, acid or base catalyst and water. At the end of such hydrolysis or polycondensation reactions, additional self assembling molecular porogen may be added in quantities ranging from about 0.1 to 5 wt. %.

Initial addition of the molecular porogen results in assimilation of the molecular porogen into the polymeric network or matrix prior to aggregation (leading to significantly smaller nanopores upon annealing) and later addition of the self assembling molecular porogen results in molecular aggregation during coating leading to larger pores upon annealing. Thus both smaller and larger pores could be obtained in one annealing step using this sol-gel system.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow chart of one embodiment of a method for forming a low refractive index porous coating on a substrate according to embodiments described herein;

FIG. 2A is a schematic diagram illustrating one embodiment of a sol-gel composition comprising a self assembling molecular porogen coated on a substrate according to embodiments described herein;

FIG. 2B is a schematic diagram illustrating one embodiment of a low refractive index porous coating on a substrate according to embodiments described herein;

FIG. 3 is an enlarged schematic diagram of one embodiment of the self assembling molecular porogen of FIG. 2A;

FIG. 4 is a schematic diagram illustrating one embodiment of a porous coating on a transparent substrate according to embodiments described herein; and

FIG. 5 is a schematic diagram illustrating one embodiment of a photovoltaic cell comprising a porous coating according to embodiments described herein.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the invention relate generally to methods and compositions for forming porous low refractive index coatings on substrates. More specifically, embodiments of the invention relate generally to sol-gel processes and sol-gel compositions for forming low refractive index coatings on transparent substrates.

The term “micelle” as used herein is an aggregate of surfactant molecules dispersed in a liquid colloid. A typical micelle in aqueous solution forms an aggregate with the hydrophobic head regions of the surfactant molecules in contact with the surrounding solvent, sequestering the hydrophobic tail regions of the surfactant molecules in the micelle center. This phase is caused by insufficient packing issues of single tailed lipids in a bilayer. The difficulty filling all the volume of the interior of a bilayer, while accommodating the area per head group leads to the formation of the micelle. Micelles are approximately spherical in shape. However, other shapes such as ellipsoids, cylinders, and bi-layers are also possible. The shape and size of a micelle is a function of the molecular geometry of its surfactant molecules and solution conditions such as surfactant concentration, temperature, pH, and ionic strength. The shape and size of the micelle will also dictate pore size and shape in the final coating.

The term “molecular porogen” as used herein is any chemical compound capable of forming a sol-gel composition which burns off upon combustion to form a void space or pore.

The term “porosity” as used herein is a measure of the void spaces in a material, and may be expressed as a fraction, the “pore fraction” of the volume of voids over the total volume, between 0 and 1, or as a percentage between 0 to 100%.

The term “self assembling molecular porogens” as used herein is a molecular porogen, generally comprising surfactant molecules, which adopts a defined arrangement without guidance or management from an outside source. Assembly is generally directed through noncovalent interactions as well as electromagnetic interactions. One example is the formation of micelles by surfactant molecules above a critical micelle concentration.

The term “sol-gel composition” as used herein is a chemical solution comprising at least a film forming precursor and at least one self assembling molecular porogen. The film forming precursor forms a polymer which upon annealing forms a porous coating.

The term “sol-gel process” as used herein is a process where a wet formulation (the “sol”) is dried to form a gel coating having both liquid and solid characteristics. The gel coating is then heat treated to form a solid material. The gel coating or the solid material may be formed by applying a thermal treatment to the sol. This technique is valuable for the development of coatings because it is easy to implement and provides films of uniform composition and thickness.

The term “surfactant” as used herein is an organic compound that lowers the surface tension of a liquid and contains both hydrophobic groups and hydrophilic groups. Thus the surfactant contains both a water insoluble component and a water soluble component.

Certain embodiments of the invention relate to a wet chemical film deposition process using a specific sol-gel system including at least one self assembling molecular porogen to produce porous coatings with a low refractive index (e.g., lower than glass). It has been found by the inventors that the self assembling molecular porogens will self assemble during the coating process, disperse in the gel-phase of the wet film and decompose to form voids upon heating.

Use of the self assembling molecular porogens leads to the formation of stable pores with larger volume and an increased reduction in the refractive index of the coating. Further, the size and interconnectivity of the pores may be controlled via selection of the self assembling molecular porogen structure, the total porogen fraction, polarity of the molecule and solvent, and other physiochemical properties of the gel phase.

In addition to the self-assembling molecular porogen, the sol-gel system further includes a film forming precursor which forms the primary structure of the gel and the resulting solid coating. Exemplary film forming precursors include silicon containing precursors and titanium based precursors. The sol-gel system may further include alcohol and water as the solvent system, and either an inorganic or organic acid or base as a catalyst or accelerator. A combination of the aforementioned chemicals leads to formation of sol through hydrolysis and condensation reactions. Various coating techniques, including dip-coating, spin coating, spray coating, roll coating, capillary coating, and curtain coating as examples, may be used to coat thin films of these sols onto a solid substrate (e.g., glass). During the coating process, a substantial amount of solvent evaporates leading to a sol-gel transition with formation of a wet film (e.g., a gel). Around or during the sol-gel transition, the molecular porogens or surfactants self assemble to form nanostructures known as micelles. The deposited wet thin films containing micelles or porogen nanostructures may then be heat treated to remove excess solvent and annealed at an elevated temperature to create a polymerized —Si—O—Si— or —Ti—O—Ti— network and remove all excess solvent and reaction products formed by oxidation of the self assembled porogen molecules, thus leaving behind a porous film with a low refractive index, where n is less than 1.3, to ultra low refractive index where n is less than 1.2. Various methods may be used to impart hydrophobicity and dust resistance (self cleaning) to these porous low refractive index films. These methods may further include the use of trisiloxane surfactants as molecular porogens, which is believed to also increase the moisture resistance of the films, application of a hydrophobic self assembled monolayer after AR coating formation, and sealing of the pores using a plasma treatment or molecular masking layer such as a few nanometers thick of a metal oxide layer.

The low refractive index porous coatings formed by sol-gel processes described herein were developed using combinatorial methods of optimizing the sol-gel formulations and conditions used to create those coatings. Combinatorial processing may include any processing that varies the processing conditions in two or more substrates or regions of a substrate. The combinatorial methodology includes multiple levels of screening to select the coatings for further variation and optimization. Exemplary combinatorial methods and apparatus are described in co-pending U.S. patent application Ser. No. 12/970,638, filed Dec. 16, 2010 and titled HIGH-THROUGHPUT COMBINATORIAL DIP-COATING APPARATUS AND METHODOLOGIES.

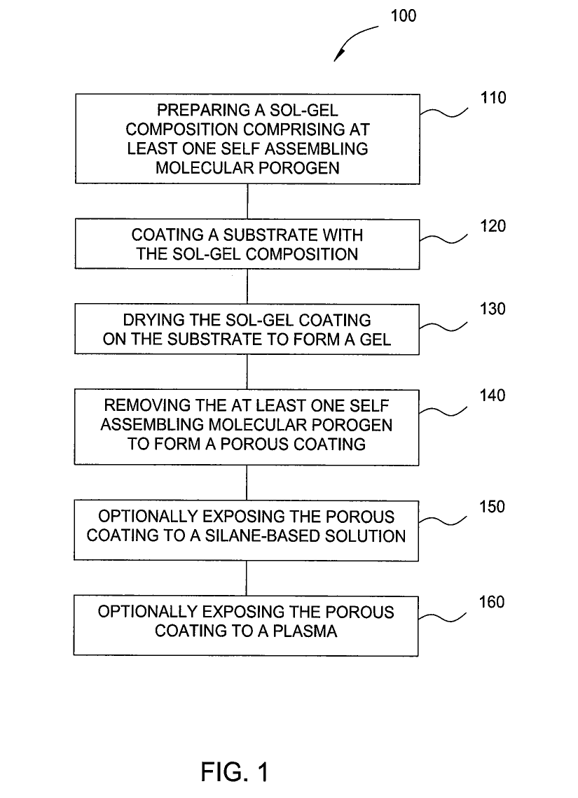

FIG. 1 is a flow chart of one embodiment of a method 100 for forming a low refractive index porous coating on a substrate according to embodiments described herein. The low refractive index porous coating may be a porous oxide coating such as a porous silicon oxide (SiₓO_{y}) coating or a porous titanium oxide (Tiₓ0_{y}) coating. At block 110, a sol-gel composition (e.g., a sol-gel formulation) comprising at least one self assembling molecular porogen is prepared.

In one embodiment, the sol-gel composition may be prepared by mixing a film forming precursor, an acid or base containing catalyst, and a solvent system containing alcohol and water to form a reaction mixture by at least one of a hydrolysis and polycondensation reaction. The reaction mixture may be stirred at room temperature or at an elevated temperature (e.g., 50-60 degrees Celsius) until the reaction mixture is substantially in equilibrium (e.g., for a period of 24 hours). The reaction mixture may then be cooled and additional solvent added to reduce the ash content if desired.

In certain embodiments, the self assembling molecular porogen may be added to the reaction mixture prior to stirring the reaction mixture. If the self assembling molecular porogen is added to the reaction mixture prior to stirring, the self assembling molecular porogen may play a part in the hydrolysis reaction. In certain embodiments, the self assembling molecular porogen may be added to the reaction mixture subsequent to stirring the reaction mixture.

In embodiments where a base catalyst is used, it may be preferable to add the self assembling molecular porogen after stirring the reaction mixture. Not to be bound by theory, but it is believed that sol-gels formed using base catalysts exhibit the formation of particles and that such particles may encapsulate the self assembling molecular porogen molecules thus preventing the formation of aggregates and micelles and their outgassing which forms the pores of controllable size and shape.

In certain embodiments, a molecular porogen which may be a self assembling molecular porogen is added in quantities ranging from 0.01 to 0.1 wt. % in the beginning of at least one of a hydrolysis and polycondensation reaction along with the film forming precursor, alcohol, acid or base catalyst and water. Exemplary molecular porogens include decomposable hydrocarbons coupled with silane such as 3-glycocidoxylpropyltrimethoxysilane (glymo). At the end of such hydrolysis or polycondensation reactions, additional self assembling molecular porogens may be added in quantities ranging from about 0.1 to 5 wt. %. Initial addition of the molecular porogen results in assimilation of the molecular porogen into the polymeric network or matrix (leading to significantly smaller nanopores upon annealing) and later addition of the self assembling molecular porogen results in molecular aggregation during coating leading to larger pores upon annealing. Thus both smaller and larger pores could be obtained in one annealing step using this sol-gel system.

The self assembling molecular porogen may be a surfactant selected from the group comprising: non-ionic surfactants, cationic surfactants, anionic surfactants, and combinations thereof. Exemplary non-ionic surfactants include non-ionic surfactants with linear hydrocarbon chains and non-ionic surfactants with hydrophobic trisiloxane groups. The self assembling molecular porogen may be a trisiloxane surfactant. Exemplary trisiloxane surfactants include polyalkyleneoxide modified hepta-methyltrisiloxane. Exemplary self assembling molecular porogens may be selected from the group comprising: polyoxyethylene stearyl ether, benzoalkoniumchloride (BAC), cetyltrimethylammoniumbromide (CTAB), 3-glycidoxypropyltrimethoxysilane, polyethyleneglycol (PEG), ammonium lauryl sulfate (ALS), dodecyltrimethylammoniumchloride (DTAC), polyalkyleneoxide modified hepta-methyltrisiloxane, and combinations thereof.

Exemplary self assembling molecular porogens are commercially available from Momentive Performance Materials under the tradename SILWET® surfactants and from SIGMA-ALDRICH® under the tradename BRIJ® surfactants. Suitable commercially available products of that type include SILWET® L-77 surfactant and BRIJ® 78 surfactant.

The self assembling molecular porogen may comprise at least 0.1 wt. %, 0.5 wt. %, 1 wt. %, or 3 wt. % of the total weight of the sol-gel composition. The self assembling molecular porogen may comprise at least 0.5 wt. %, 1 wt. %, 3 wt. % or 5 wt. % of the total weight of the sol-gel composition The self assembling molecular porogen may be present in the sol-gel composition in an amount between about 0.1 wt. % and about 5 wt. % of the total weight of the sol-gel composition.

The use of self assembling molecular porogens allows the user to control both the size and shape of the pores in the coating through selection of the molecular geometry of its surfactant molecules and solution conditions such as surfactant concentration, temperature, pH, and ionic strength.

The sol-gel composition further includes a film forming precursor which forms the primary structure or network of the gel and the resulting solid coating. The film forming precursor may be a silicon containing precursor or a titanium containing precursor. Exemplary silicon containing precursors include silane and silicon alkoxide containing precursors. The silicon containing precursor may be in liquid form. Exemplary silicon containing precursors include alkyl containing silicon precursors such as tetraalkylorthosilicate, alkyltrialkoxysilane, alkyltrialkylsilane (where each alkyl group may independently be any alkyl group, such as methyl, ethyl, propyl, butyl, pentyl, hexyl, heptyl, octyl, nonyl, decyl, etc.). Exemplary silane containing precursors or metal alkoxide containing precursors may be selected from the group comprising: tetraethylorthosilicate (TEOS), 3-glycidoxypropyltrimeth oxysilane (Glymo), octadecyltrimethoxysilane (OTS), propyltriethoxysilane (PTES), methyltriethoxysilane (MTES), (heptadecafluoro) 1,1,2,2-tetrahydrodecyltrimethoxysilane, hexamethyldisilazane (HMDS), and

PATENT combinations thereof. Exemplary titanium precursors include titanium alkoxide and titanium chloride precursors.

For certain embodiments which use longer alkyl chain silanes such as 3-glycocidoxylpropyltrimethoxysilane (glymo) as the silicon containing precursor, these longer alkyl chain silanes form micropores (pores less than 1 nanometer in size) due to the combustion of the alkyl (hydrocarbon) chain. In this case, the longer alkyl chain silane molecule itself acts as a molecular porogen. These longer alkyl chain silanes may be used as a precursor in conjunction with a self assembling molecular porogen, such as a trisiloxane surfactant, to produce porous coating having a combination of macropores and micropores.

The amount of film forming precursor may comprise at least 1 wt. %, 3 wt. %, 5 wt. %, 7 wt. %, 9 wt. %, 11 wt. %, 13 wt. %, 15 wt. %, 17 wt. %, or 19 wt. % of the total weight of the sol-gel composition. The amount of film forming precursor may comprise up to 3 wt. %, 5 wt. %, 7 wt. %, 9 wt. %, 11 wt. %, 13 wt. %, 15 wt. %, 17 wt. %, 19 wt. %, or 20 wt. % of the total weight of the sol-gel composition. The film forming precursor may be present in the sol-gel composition in an amount between about 1 wt. % and about 20 wt. % of the total weight of the sol-gel composition. The amount of film forming precursor may correspond to 1-5% final ash content in the final sol composition.

The sol-gel composition further includes an acid or base catalyst for controlling the rates of hydrolysis and condensation. The acid or base catalyst may be an inorganic or organic acid or base catalyst. Exemplary acid catalysts may be selected from the group comprising hydrochloric acid (HCl), nitric acid (HNO₃), sulfuric acid (H₂SO₄), acetic acid (CH₃COOH), and combinations thereof. Exemplary base catalysts include tetramethylammonium hydroxide (TMAH).

The acid catalyst level may be 0.001 to 10 times stoichiometric molar precursor (the film forming precursor). The acid catalyst level may be from 0.001 to 0.1 times molar precursor (the film forming precursor). The base catalyst level may be 0.001 to 10 times stoichiometric molar precursor (the film forming precursor). The base catalyst level may be from 0.001 to 0.1 times molar precursor (the film forming precursor).

The sol-gel composition further includes a solvent system. The solvent system may include a non-polar solvent, a polar aprotic solvent, a polar protic solvent, and combinations thereof. Selection of the solvent system and the self assembling molecular porogen may be used to influence the formation and size of micelles. Exemplary solvents include alcohols, for example, n-butanol, isopropanol, n-propanol, ethanol, methanol, and other well known alcohols. The solvent system may further include water. Water may be present in 0.5 to 10 times the stoichiometric amount need to hydrolyze the silicon containing precursor molecules.

At block 120, a substrate is coated with the sol-gel composition. Exemplary substrates include glass, silicon, metallic coated materials, or plastics. The substrate may be a transparent substrate. The substrate could be optically flat, textured, or patterned. The substrate may be flat, curved or any other shape as necessary for the application under consideration. Exemplary glass substrates include high transmission low iron glass, borosilicate glass (BSG), sodalime glass and standard clear glass. The sol-gel composition may be coated on the substrate using, for example, dip-coating, spin coating, curtain coating, roll coating, capillary coating, or a spray coating process. Other application methods known to those skilled in the art may also be used. The substrate may be coated on a single side or on multiple sides.

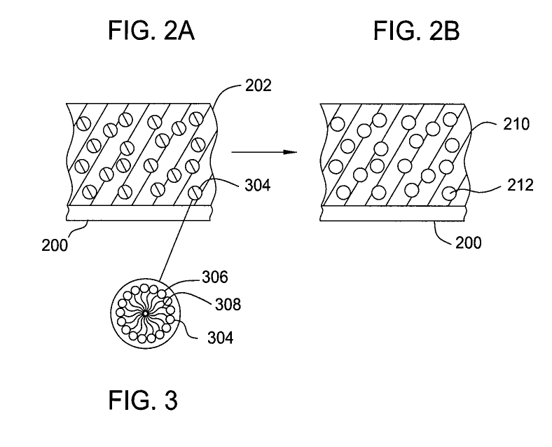

FIG. 2A is a schematic diagram illustrating one embodiment of a sol-gel composition 202 comprising a self assembling molecular porogen 204 coated on a substrate 200 according to embodiments described herein. As shown in FIG. 2A, a sol-gel 202 comprising the self assembling molecular porogen 304 is coated on a substrate 210. With reference to FIG. 3, the self assembling molecular porogen 304 comprises a plurality of surfactant molecules with the hydrophobic head regions 306 of the surfactant molecules in contact with the surrounding solvent, sequestering the hydrophobic tail regions 308 of the surfactant molecules in the micelle center to form a micelle structure.

Referring back to FIG. 1 at block 130, the coating on the substrate is dried to form a gel. A gel is a coating that has both liquid and solid characteristics and may exhibit an organized material structure (e.g., a water based gel is JELL-O®).

During the drying, the solvent of the sol-gel composition is evaporated and further bonds between the components, or precursor molecules, may be formed. The drying may be performed by exposing the coating on the substrate to the atmosphere at room temperature. The coatings (and/or the substrates) may alternatively be exposed to a heated environment at an elevated temperature above the boiling point of the solvent. The drying of the coatings may not require elevated temperatures, but may vary depending on the formulation of the sol-gel compositions used to form the coatings. In one embodiment, the drying temperature may be in the range of approximately 25 degrees Celsius to approximately 200 degrees Celsius. In one embodiment, the drying temperature may be in the range of approximately 50 degrees Celsius to approximately 60 degrees Celsius. The drying process may be performed for a time period of between about 1 minute and 10 minutes, for example, about 6 minutes. Drying temperature and time are dependent on the boiling point of the solvent used during sol formation.

At block 140, the at least one self assembling molecular porogen is removed to form the porous silicon oxide coating. The at least one self assembling molecular porogen may be removed by exposing the coating (and/or substrate) to an annealing process to form a porous coating. The annealing temperature and time may be selected based on the chemical composition of the sol-gel compositions, depending on what temperatures may be required to form cross-linking between the components throughout the coating. In one embodiment, the annealing temperature may be in the range of 500 degrees Celsius and 1,000 degrees Celsius. In one embodiment, the annealing temperature may be 600 degrees Celsius or greater. In another embodiment, the annealing temperature may be between 625 degrees Celsius and 650 degrees Celsius. The annealing process may be performed for a time period of between about 3 minutes and 1 hour, for example, about 6 minutes.

FIG. 2B is a schematic diagram illustrating one embodiment of a low refractive index porous coating 210 on a substrate 200 after removal of the self assembling molecular porogen to form pores 212 according to embodiments described herein.

The porous coating may have a thickness greater than 50 nanometers. The porous coating may have a thickness between about 50 nanometers and about 1,000 nanometers. The porous coating may have a thickness between about 100 nanometers and about 200 nanometers. The porous coating may have a thickness of about 150 nanometers.

The pores of the porous coating may on average be between about 2 nanometers and about 10 nanometers. The pores of the porous coating may on average be between about 2 nanometers and about 3 nanometers. The porous coating may have a pore fraction of between about 0.3 and about 0.6.

In one embodiment, the coating may be a single coating. In alternate embodiments, the coating may be formed of multiple coatings on the same substrate. In such an embodiment, the coating, gel-formation, and annealing may be repeated to form a multi-layered coating with any number of layers. The multi-layers may form a coating with graded porosity. For example, in certain embodiments it may be desirable to have a coating which has a higher porosity adjacent to air and a lower porosity adjacent to the substrate surface. A graded coating may be achieved by modifying various parameters, such as, the type of self assembling molecular porogen, the anneal time, the anneal temperature, the use of mixed porogens, and the order of addition of various porogens to the sol-gel system.

Referring back to FIG. 1 at block 150, the porous coating may optionally be exposed to a silane-based solution. Exposing the porous coating to a silane-based solution will impart hydrophobic properties to the film leading to reduced moisture content. Not to be bound by theory but it is believed that a portion of the silane forms a covalent bond with the network while a hydrophobic portion of the silane remains exposed forming a hydrophobic monolayer which repels water. The silane-based solution may include a solvent and a silane. Exemplary solvents include ethanol, propanol, butanol chloroform, and dimethylformamide (DMF). Exemplary silanes include silanes selected from the group comprising propyltriethoxysilane (PTES), octadecyltrimethoxysilane (OTS), (heptadecafluoro)-1,1,2,2-tetrahydrodecyltrimethoxysilane, hexamethyldisilazane (HMDS), and combinations thereof. The concentration of the silane could be from 1 micromolar to 10 milimolar in one of the aforementioned solvents. It should also be noted that these silane based solutions may be reapplied to the porous coating if needed to maintain the hydrophobic properties.

At block 160, the porous coating may be exposed to plasma to seal the top layer of the pores to make the film more moisture resistant while preserving the optical properties of the film. The plasma may be RF or DC plasma. In certain embodiments, the pores may be sealed using a molecular masking layer. One exemplary masking layer includes a polymeric layer which may be a few nanometers thick and doesn't significantly impact the overall refractive index of the film. Another exemplary masking layer could be a vacuum deposited metal oxide layer of 2-5 nanometers thickness such as TiO₂.

### EXAMPLES

Objects and advantages of the embodiments described herein are further illustrated by the following examples. The particular materials and amounts thereof, as well as other conditions and details, recited in these examples should not be used to limit embodiments described herein. Unless stated otherwise all percentages, parts and ratios are by weight. Examples of the invention are numbered while comparative samples, which are not examples of the invention, are designated alphabetically.

### Example #1

Tetraethylorthosilicate (TEOS) corresponding to 3% total ash content (based on equivalent weight of SiO₂ produced) in the final composition was mixed with water (2 times stoichiometric amount based on TEOS), nitric acid (0.02 times the molar TEOS amount) and n-propanol (10-100 times molar TEOS). The solution was stirred for 24 hours at room temperature or elevated temperature (50-60 degrees Celsius). The solution was cooled to room temperature and mixed with an additional amount of n-propanol to bring the total ash content of the solution to 3%. SILWET® L-77 surfactant was added to this solution at 3% mass level to act as a molecular porogen. The solution was either dip (coating speed ˜10 mm/sec) or spin coated (1,000-1,400 rpm) on pre-cleaned borosilicate (BSG) or sodalime glass to achieve a film thickness of around ˜150 nanometers after annealing. The glass substrate was then dried at 150 degrees Celsius for 30 minutes in an oven to evaporate all the solvent and then annealed at 625-650 degrees Celsius for 6 minutes. The glass substrate was cooled on a steel slab and characterized to determine the film thickness, refractive index (RI) and improvement in transmittance of light.

A refractive index value of n˜1.25 was achieved with an improvement in percentage transmission averaged over a wavelength range of 400-1,200 nanometers of around 3% for single sided coating on glass compared with the data of uncoated glass. SEM data of the film demonstrated that it was continuous (no cracks) and had pores of approximately 2 to 4 nanometers in diameter distributed throughout its surface and thickness. Ellipsometric porosimetry techniques were utilized to analyze pore size and distribution, which further confirmed the presence of a pore size of approximately 2 to 3 nanometers with a narrow size distribution. cl Example #2

A porous AR coating prepared as described in example #1 was treated with 10 mM of PTES solution prepared in n-propanol for 20 minutes, dried using nitrogen and stored along with untreated film.

The impact of moisture absorption was studied on both the PTES treated samples and untreated samples. The treated and untreated samples were exposed to atmosphere and the refractive index of the treated and untreated samples was monitored over time (e.g., every twenty-four hours). It was observed that the coating modified using PTES retained its optical properties better than the untreated film over one week's time (RI, % transmission change etc). Thus the film treated with PTES was more hydrophobic or moisture resistant than the untreated porous coating.

### Example #3

A porous coating prepared as described in example #1 was treated in a vacuum oven containing HMDS vapors mixed with nitrogen for approximately 15 minutes and stored along with an untreated film.

The impact of moisture absorption was studied on both the HDMS treated samples and the untreated samples and it was observed that the porous coating modified using HMDS retained its optical properties better than the untreated film over one week's time. Thus the film treated with HMDS was more hydrophobic or moisture resistant than the untreated porous coating.

### Example #4

Tetraethylorthosilicate (TEOS) corresponding to 3% total ash content (based on equivalent weight of SiO₂ produced) in the final composition was mixed with water (2 times stoichiometric amount based on TEOS), nitric acid (0.02 times the molar TEOS amount) and n-propanol (10-100 times molar TEOS). The solution was stirred for 24 hours at room temperature or elevated temperature (50-60 degrees Celsius). The solution was cooled to room temperature and mixed with an additional amount of n-propanol to bring the total ash content of the solution to ˜3%. BRIJ® 78 surfactant was added to this solution at 3% mass level to act as a molecular porogen. The solution was either dip (coating speed ˜10 mm/sec) or spin coated (1,000-1,400 rpm) on pre-cleaned borosilicate (BSG) or sodalime glass to achieve a film thickness of around ˜150 nanometers after annealing. The glass substrate was then dried at 150 degrees Celsius for 30 minutes in an oven to evaporate all the solvent and then annealed at 625-650 degrees Celsius for 6 minutes. The glass substrate was cooled on a steel slab and characterized to determine the film thickness, refractive index (RI) and improvement in transmittance of light.

### Example #5

Tetraethylorthosilicate (TEOS) corresponding to 3% total ash content (based on equivalent weight of SiO₂ produced) in the final composition was mixed with water (2 times stoichiometric amount based on TEOS), tetramethylammoniun hydroxide (0.02 times the molar TEOS amount) and n-propanol (10-100 times molar TEOS). The solution was stirred for 24 hours at room temperature or elevated temperature (50-60 degrees Celsius). The solution was cooled to room temperature and mixed with an additional amount of n-propanol to bring the total ash content of the solution to ˜3%. BRIJ® 78 surfactant was added to this solution at 3% mass level to act as a molecular porogen. The solution was either dip (coating speed ˜10 mm/sec) or spin coated (1,000-1,400 rpm) on pre-cleaned borosilicate (BSG) or sodalime glass to achieve a film thickness of around ˜150 nanometers after annealing. The glass substrate was then dried at 150 degrees Celsius for 30 minutes in an oven to evaporate all the solvent and then annealed at 625-650 degrees Celsius for 6 minutes. The glass substrate was cooled on a steel slab and characterized to determine the film thickness, refractive index (RI) and improvement in transmittance of light.

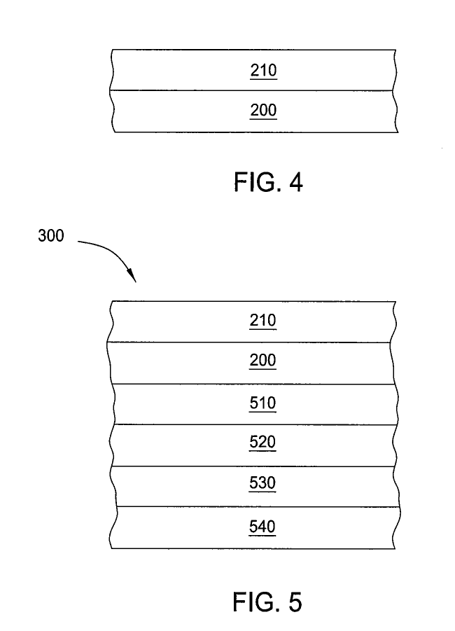

FIG. 4 is a schematic diagram illustrating one embodiment of a porous antireflective coating (ARC) 210 on a glass substrate 200 according to embodiments described herein. The porous antireflective coating 210 was produced using sol-gel compositions comprising the self assembling molecular porogen and methods as described herein.

FIG. 5 is a schematic diagram illustrating one embodiment of a photovoltaic cell 500 comprising a porous antireflective coating formed from sol-gel compositions comprising the self assembling molecular porogen and methods as described herein. The photovoltaic cell 500 comprises the glass substrate 200 and the porous antireflective coating 210 as shown in FIG. 4. In this example embodiment, the incoming or incident light from the sun or the like is first incident on the AR coating 210, passes therethrough and then through the glass substrate 200 and front transparent conductive electrode before reaching the photovoltaic semiconductor (active film) 520 of the solar cell. The photovoltaic cell 500 may also include, but does not require, a reflection enhancement oxide and/or EVA film 530, and/or a back metallic or otherwise conductive contact and/or reflector 540 as shown in FIG. 5. Other types of photovoltaic devices may of course be used, and the photovoltaic device 500 is merely exemplary. As explained above, the AR coating 210 may reduce reflections of the incident light and permits more light to reach the thin film semiconductor film 520 of the photovoltaic device 500 thereby permitting the device to act more efficiently.

Embodiments described herein provide improved low refractive index porous coatings which exhibit increased durability. The embodiments described herein also provide for control over the shape and size of the pores formed within the low refractive index porous coating.

It has also been found that porous coatings prepared using a trisiloxane surfactant such as SILWET® L-77 surfactant exhibited moisture resistant properties even absent post treatment with a silane-based solution. This phenomenon was not observed when non-ionic surfactants were used as the self assembling molecular porogen. Thus trisiloxane based surfactants used as a molecular porogen could also impart hydrophobicity to the film. Sol-gel compositions prepared using trisiloxane surfactants as the molecular porogen were also found to be clear and stable over a period of several months. Compositions without the trisiloxane surfactant seemed to turn cloudy. Thus trisiloxane based surfactants are believed to provide longer term stability to the sol-gel compositions.

While the foregoing is directed to embodiments of the invention, other and further embodiments of the invention may be devised without departing from the basic scope thereof.

What is claimed is:

1. A method of forming a porous coating on a substrate, comprising:
coating the substrate with a sol-gel composition comprising at least one self assembling molecular porogen; and
annealing the coated substrate to remove the at least one self assembling molecular porogen to form the porous coating.

2. The method of claim 1, wherein the self assembling molecular porogen is a trisiloxane surfactant.

3. The method of claim 1, wherein the self assembling molecular porogen is selected from the group comprising: polyoxyethylene stearyl ether, benzoalkoniumchloride (BAC), cetyltrimethylammoniumbromide (CTAB), 3-glycidoxypropyltrimethoxysilane, polyethyleneglycol (PEG), ammonium lauryl sulfate (ALS), dodecyltrimethylammoniumchloride (DTAC), polyalkyleneoxide modified hepta-methyltrisiloxane, and combinations thereof.

4. The method of claim 2, wherein the self assembling molecular porogen is present in the sol-gel composition in an amount from about 0.1 wt. % to 5 wt. % of the total weight of the sol-gel composition.

5. The method of claim 1, further comprising:
drying the sol-gel composition coated on the substrate to form a gel on the substrate.

6. The method of claim 5, wherein annealing the coated substrate to remove the at least one self-assembling molecular porogen comprises heating the gel coated on the substrate to a temperature greater than 500 degrees Celsius.

7. The method of claim 1, wherein the substrate is a glass substrate.

8. The method of claim 1, wherein the sol-gel composition further comprises a silicon containing precursor selected from the group comprising:
tetraethylorthosilicate (TEOS), 3-glycidoxypropyltrimethoxysilane, octadecyltrimethoxysilane (OTS), propyltriethoxysilane (PTES), methyltriethoxysilane (MTES), (heptadecafluoro) 1,1,2,2-tetrahydrodecyltrimethoxysilane, hexamethyldisilazane (HMDS), and combinations thereof.

9. The method of claim 8, wherein the silicon containing precursor is TEOS and the self assembling molecular porogen is polyalkyleneoxide modified hepta-methyltrisiloxane.

10. The method of claim 9, further comprising:
exposing the porous silicon oxide coating to a silane-based solution to improve the hydrophobicity of the porous silicon oxide coating.

11. The method of claim 10, wherein the silane-based solution comprises a silane selected from the group comprising propyltriethoxysilane (PTES), octadecyltrimethoxysilane (OTS), (heptadecafluoro)-1,1,2,2-tetrahydrodecyltrimethoxysilane, hexamethyldisilazane (HMDS), and combinations thereof.

12. A composition for forming a sol-gel system, comprising:
a film forming precursor;
an acid or base containing catalyst;
an alcohol containing solvent;
a self assembling molecular porogen; and
water.

13. The composition of claim 12, wherein the self assembling molecular porogen is a trisiloxane surfactant.

14. The composition of claim 12, wherein the self assembling molecular porogen is selected from the group comprising: polyoxyethylene stearyl ether, benzoalkoniumchloride (BAC), cetyltrimethylammoniumbromide (CTAB), 3-glycidoxypropyltrimethoxysilane, polyethyleneglycol (PEG), ammonium lauryl sulfate (ALS), dodecyltrimethylammoniumchloride (DTAC), polyalkyleneoxide modified hepta-methyltrisiloxane, and combinations thereof.

15. The composition of claim 14, wherein the self assembling molecular porogen is present in the sol-gel composition in an amount from about 0.1 wt. % to 5 wt. % of the total weight of the sol-gel composition.

16. The composition of claim 14, wherein the film forming precursor is a silicon containing precursor selected from the group comprising: tetraethylorthosilicate (TEOS), 3-glycidoxypropyltrimethoxysilane, octadecyltrimethoxysilane (OTS), propyltriethoxysilane (PTES), methyltriethoxysilane (MTES), (heptadecafluoro) 1,1,2,2-tetrahydrodecyltrimethoxysilane, hexamethyldisilazane (HMDS), and combinations thereof.

17. The composition of claim 16, comprising:
between 1 wt. % and 20 wt. % of the silicon containing precursor; and
between 0.1 wt. % and 5 wt. % of the self assembling molecular porogen.

18. A method of making a sol-gel system, comprising:
mixing a film forming precursor, an acid or base containing catalyst, water, and an alcohol containing solvent to form a reaction mixture by at least one of a hydrolysis and polycondensation reaction; and
subsequently adding at least one self assembling molecular porogen to the reaction mixture.

19. The method of claim 18, wherein the self assembling molecular porogen is a trisiloxane surfactant.

20. The method of claim 18, wherein the self assembling molecular porogen is selected from the group comprising: polyoxyethylene stearyl ether, benzoalkoniumchloride (BAC), cetyltrimethylammoniumbromide (CTAB), 3-glycidoxypropyltrimethoxysilane, polyethyleneglycol (PEG), ammonium lauryl sulfate (ALS), dodecyltrimethylammoniumchloride (DTAC), polyalkyleneoxide modified hepta-methyltrisiloxane, and combinations thereof.

21. The method of claim 18, further comprising:
heating the reaction mixture to between about 50 degrees Celsius and 60 degrees Celsius;
cooling the heated reaction mixture to room temperature; and
adding additional alcohol containing solvent to the cooled reaction mixture prior to the adding at least one self assembling molecular porogen.

22. The method of claim 18, wherein the film forming precursor is a silane containing precursor or metal alkoxide containing precursor selected from the group comprising: tetraethylorthosilicate (TEOS), 3-glycidoxypropyltrimethoxysilane, octadecyltrimethoxysilane (OTS), propyltriethoxysilane (PTES), methyltriethoxysilane (MTES), (heptadecafluoro) 1,1,2,2-tetrahydrodecyltrimethoxysilane, hexamethyldisilazane (HMDS), and combinations thereof.

23. The method of claim 22, wherein the silicon containing precursor is TEOS and the self assembling molecular porogen is polyalkyleneoxide modified hepta-methyltrisiloxane.
